(19) United States
(12) Patent Application Publication
(10) Pub. No.: US 2011/0189561 A1
(43) Pub. Date: Aug. 4, 2011

(54) HYDROGEN GENERATING APPARATUS AND FUEL CELL USING THE SAME

(75) Inventors: Po-Kuei Chou, Hsinchu County (TW); Cheng Wang, Hsinchu County (TW); Yueh-Chang Wu, Hsinchu County (TW); Shin-Ping Kung, HSINCHU COUNTY (TW)

(73) Assignee: YOUNG GREEN ENERGY CO., HSINCHU COUNTY (TW)

(21) Appl. No.: 13/007,673

(22) Filed: Jan. 17, 2011

(30) Foreign Application Priority Data
Feb. 1, 2010 (CN) 201010108969.2

(51) Int. Cl. H01M 8/06

(52) U.S. Cl. 429/421

(57) ABSTRACT

A hydrogen generating apparatus and a fuel cell using the same are provided, the hydrogen generating apparatus is adapted to the fuel cell, and includes a sleeve, a sliding element, and a withdrawing mechanism. A first end of the sleeve is used for containing liquid water. The sliding element is slidably disposed at a second end of the sleeve, wherein a solid fuel is connected to the sliding element. The withdrawing mechanism is disposed in the sleeve. The solid fuel is apart from the liquid water when the sliding element is fixed to a first position by the withdrawing mechanism, and the solid fuel reacts with the liquid water to generate hydrogen when the sliding element is fixed to a second position by the withdrawing mechanism.

### CROSS-REFERENCE TO RELATED APPLICATION

This application claims the priority benefit of China application serial no. 201010108969.2, filed on Feb. 1, 2010. The entirety of the above-mentioned patent application is hereby incorporated by reference herein and made a part of this specification.

### BACKGROUND

1. Field of the Disclosure

The disclosure relates to a hydrogen generating apparatus and a fuel cell using the same. More particularly, the disclosure relates to a hydrogen generating apparatus using a solid fuel, and a fuel cell using the hydrogen generating apparatus.

2. Description of Related Art

A fuel cell (FC) is a power generator in which chemical energy is directly converted into electrical power through electrochemical reaction. Compared to a conventional power generating method, the fuel cell has advantages of low pollution, low noise, high energy density, and higher energy conversion rate, etc., which is a clean energy source with a prospective future, and may be applied in various domains such as mobile electronic products, home power generation systems, transport, military equipments, space industry, and small-scale power generation systems, etc.

Various fuel cells may have different application domains due to their different operation principles and different operation environments. Proton exchange membrane fuel cells (PEMFC) and direct methanol fuel cells (DMFC) are mainly used in mobile energy applications. PEMFC and DMFC may actuate at low temperature and use proton exchange membrane for conducting protons. An operation principle of the PEMFC is that the hydrogen has an oxidation reaction at an anode catalyst layer to generate hydrogen ions (H+) and electrons (e−) (PEMFC principle), or the methanol and water have the oxidation reaction at the anode catalyst layer to generate hydrogen ions (H+), carbon dioxide (CO₂), and electrons (e−) (DMFC principle), wherein the hydrogen ions may be conducted to a cathode through the proton exchange membrane, and the electrons are first transmitted to a load through an external circuit and then are transmitted to the cathode. The oxygen is provided to the cathode and the hydrogen ions and the electrons may have a reduction reaction at a cathode catalyst layer to generate water. The hydrogen fuel required by the above anode may be obtained through a solid sodium borohydride (NaBH₄) hydrogen storage technology, by which water is added to the solid sodium borohydride for reaction, so as to generate the hydrogen.

The reaction between the solid sodium borohydride and the water is one-off reaction, namely, once the reaction is carried on, it doesn't stop until the solid sodium borohydride or the water runs out. Therefore, how to achieve a stepwise reaction is a problem to be resolved.

### SUMMARY

The invention is directed to a hydrogen generating apparatus, in which reactions between a solid fuel and water may be carried on stepwise.

The invention is directed to a fuel cell having a hydrogen generating apparatus, in which reactions between a solid fuel and water may be carried on stepwise.

Additional aspects and advantages of the invention will be set forth in the description of the techniques disclosed in the disclosure.

To achieve one of or all aforementioned and other advantages, an embodiment of the invention provides a hydrogen generating apparatus adapted to a fuel cell. The hydrogen generating apparatus includes a sleeve, a sliding element, and a withdrawing mechanism. A first end of the sleeve is used for containing liquid water. The sliding element is slidably disposed at a second end of the sleeve, wherein a solid fuel is connected to the sliding element. The withdrawing mechanism is dispose in the sleeve. The solid fuel is apart from the liquid water when the sliding element is fixed to a first position by the withdrawing mechanism, and the solid fuel reacts with the liquid water to generate hydrogen when the sliding element is fixed to a second position by the withdrawing mechanism.

To achieve one of or all aforementioned and other advantages, an embodiment of the invention provides a fuel cell including a hydrogen generating apparatus, a cell stack, and a guiding structure. The hydrogen generating apparatus includes a sleeve, a sliding element, and a withdrawing mechanism. A first end of the sleeve is used for containing liquid water. The sliding element is slidably disposed at a second end of the sleeve, wherein a solid fuel is connected to the sliding element. The withdrawing mechanism is disposed in the sleeve. The solid fuel is apart from the liquid water when the sliding element is fixed to a first position by the withdrawing mechanism, and the solid fuel reacts with the liquid water to generate hydrogen when the sliding element is fixed to a second position by the withdrawing mechanism. The guiding structure is connected between the hydrogen generating apparatus and the cell stack, and is used for guiding the hydrogen generated through reaction between the solid fuel and the liquid water to the cell stack.

According to the above descriptions, the embodiments of the invention have at least one of the following advantages. The sliding element slidably disposed on the sleeve may be fixed to the first position and the second position by the withdrawing mechanism, so that the solid fuel connected to the sliding element may be close to or apart from the liquid water contained in one end of the sleeve. In this way, the solid fuel may react with the liquid water to generate the hydrogen or the reaction between the solid fuel and the liquid water may be stopped to achieve an effect of stepwise reaction.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the embodiment of the invention, and are incorporated in and constitute a part of this specification. The drawings illustrate embodiments of the invention and, together with the description, serve to explain the principles of embodiments of the invention.

FIG. 1 is a schematic diagram illustrating a hydrogen generating apparatus according to an embodiment of the invention.

FIG. 2 is a schematic diagram illustrating a motion of a sliding element of FIG. 1.

FIG. 3 is a schematic diagram illustrating a hydrogen generating apparatus according to another embodiment of the invention.

FIG. 4 is a schematic diagram illustrating a motion of a sliding element of FIG. 3.

FIG. 5 is a schematic diagram illustrating a part of elements of a hydrogen generating apparatus according to another embodiment of the invention.

FIG. 6 is a schematic diagram illustrating a fuel cell applying a hydrogen generating apparatus of FIG. 1.

### DESCRIPTION OF THE EMBODIMENTS

In the following detailed description of the embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

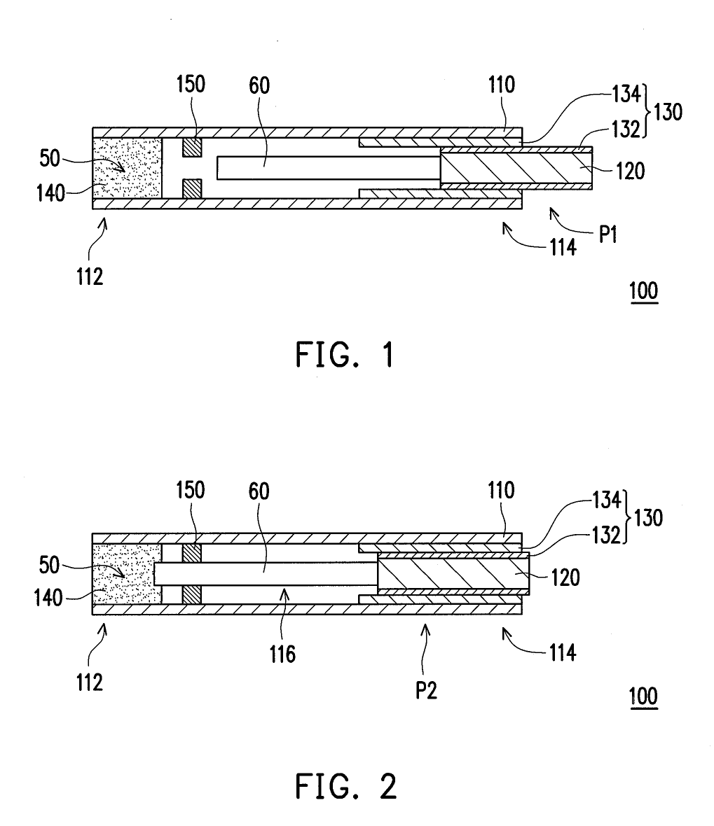

FIG. 1 is a schematic diagram illustrating a hydrogen generating apparatus according to an embodiment of the invention. FIG. 2 is a schematic diagram illustrating a motion of a sliding element of FIG. 1. Referring to FIG. 1 and FIG. 2, the hydrogen generation apparatus 100 of the embodiment is used in a fuel cell for providing hydrogen required by a reaction at an anode of the fuel cell. The hydrogen generation apparatus 100 includes a sleeve 110, a sliding element 120, and a withdrawing mechanism 130. A first end 112 of the sleeve 110 is used for containing liquid water 50. The sliding element 120 is slidably disposed at a second end 114 of the sleeve 110, and a solid fuel 60 is connected to the sliding element 120. The sliding element 120 may move between a position P1 (shown in FIG. 1) and a position P2 (shown in FIG. 2) relative to the sleeve 110, and may be fixed to the position P1 or the position P2 through the withdrawing mechanism 130.

In detail, the withdrawing mechanism 130 of the embodiment is formed by an external thread 132 and an internal thread 134 engaged to each other, wherein the external thread 132 is disposed on an outer surface of the sliding element 120, and the internal thread 134 is disposed on an inner wall of the sleeve 110. A user may rotate the sliding element 120 to move the sliding element 120 relative to the sleeve 110 between the position P1 and the position P2 in a spiral approach. When the sliding element 120 is located at the position P1, the solid fuel 60 is apart from the liquid water 50. When the sliding element 120 is located at the position P2, the solid fuel 60 contacts the liquid water 50 and reacts with the liquid water 50 to generate hydrogen. Therefore, by moving the sliding element 120, the solid fuel 60 may react with the liquid water 50 to generate the hydrogen or the reaction between the solid fuel 60 and the liquid water 50 may be stopped to achieve an effect of stepwise reaction.

In the embodiment, the solid fuel 60 is, for example, solid sodium borohydride (NaBH₄), though the invention is not limited thereto, and other types of solid fuel may also be used. Furthermore, the hydrogen generating apparatus 100 of the embodiment may further include a water absorbing structure 140. The water absorbing structure 140 is disposed in the first end 112 of the sleeve 110, and is used for absorbing the liquid water 50 to form hydrogel, so as to fix the liquid water 50 within the sleeve 110 to avoid leakage of the liquid water 50.

Moreover, the hydrogen generating apparatus 100 of the embodiment further includes a water wiper 150. The water wiper 150 is disposed in the sleeve 110 and is located between the sliding element 120 and the liquid water 50, which is used to collect the hydrogen generated through the reaction between the liquid water 50 and the solid fuel 60 without wasting. In detail, during a process that the sliding element 120 moves from the position P2 shown in FIG. 2 to the position P1 shown in FIG. 1, the water wiper 150 wipes the liquid water 50 attached on the solid fuel 60 to avoid a situation that the liquid water 50 moves along with the solid fuel 60 to reach a central region 116 of the sleeve 110, so as to ensure that the reaction between the liquid water 50 and the solid fuel 60 is occurred at the first end 112 of the sleeve 110, so that the generated hydrogen is easy to be collected for utilization.

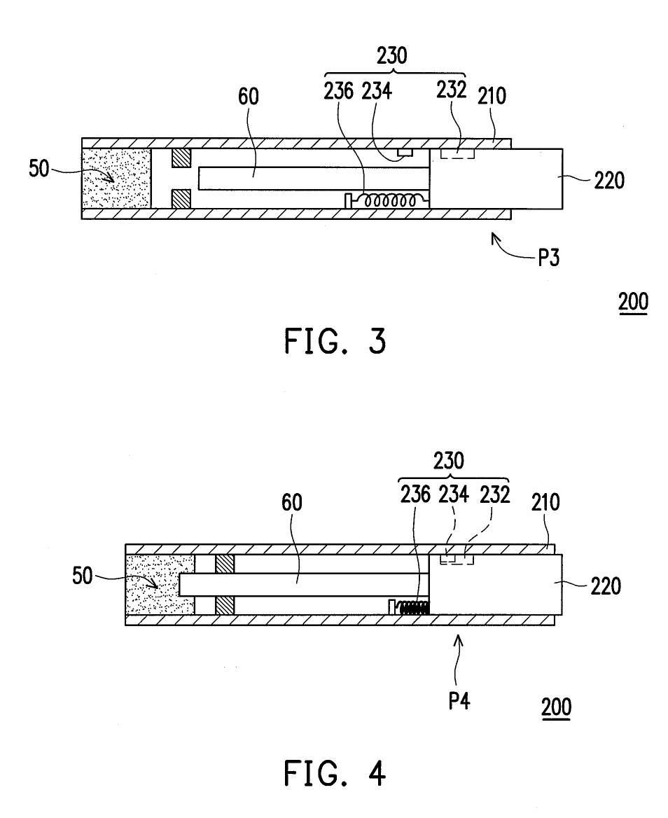

It should be noticed that besides the external thread 132 and the internal thread 134, the withdrawing mechanism 130 may also be formed by other elements, which is described below with reference of FIG. 3 and FIG. 4.

FIG. 3 is a schematic diagram illustrating a hydrogen generating apparatus according to another embodiment of the invention. FIG. 4 is a schematic diagram illustrating a motion of a sliding element of FIG. 3. Referring to FIG. 3 and FIG. 4, in the hydrogen generating apparatus 200 of the embodiment, the withdrawing mechanism 230 includes a first buckle element 232, a second buckle element 234, and an elastic element 236. The first buckle element 232 is disposed on an outer surface of a sliding element 220, the second buckle element 234 is disposed on an inner surface of a sleeve 210, and the elastic element 236 is connected between the sleeve 210 and the sliding element 220. When the sliding element 220 is located at a position P4 shown in FIG. 4, the first buckle element 232 and the second buckle element 234 form a structural interference, so as to fix the sliding element 220 at the position P4. When the structural interference between the first buckle element 232 and the second buckle element 234 is released, the sliding element 220 is restored to the position P3 shown in FIG. 3 due to an elastic force of the elastic element 236.

In this way, when the solid fuel 60 connected to the sliding element 210 is required to be reacted with the liquid water 50 to generate hydrogen, the user may press the sliding element 220 to resist the elastic force of the elastic element 236, so as to move the sliding element 220 from the position P3 shown in FIG. 3 to the position P4 shown in FIG. 4 to contact the solid fuel 60 with the liquid water 50, and fix the sliding element 220 to the position P4 through the structural interference between the first buckle element 232 and the second buckle element 234. When the reaction between the solid fuel 60 and the liquid water 50 is required to be stopped, the structural interference between the first buckle element 232 and the second buckle element 234 may be released, and the sliding element 220 is pushed back to the position P3 by the elastic force of the elastic element 236, so that the solid fuel 60 is apart from the liquid water 50 to achieve the effect of stepwise reaction. Formations, an engaging approach, and a detaching approach of the buckle element 232 and the second buckle element 234 are not limited by the invention, and any combination of buckles capable of implementing the above motion may be used.

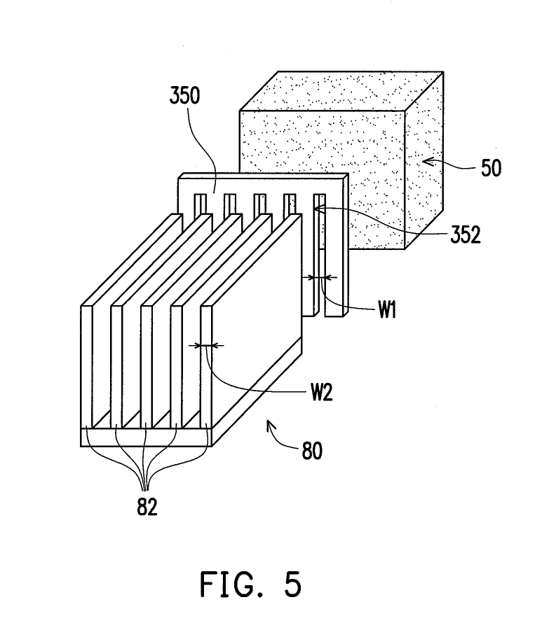

FIG. 5 is a schematic diagram illustrating a part of elements of a hydrogen generating apparatus according to another embodiment of the invention. Referring to FIG. 5, a solid fuel of the embodiment includes a plurality of fuel blocks 82. The fuel blocks 82 are separately arranged, and a water wiper 350 has a plurality of slots 352 aligning to the fuel blocks 82, so that when the solid fuel 80 passes through the water wiper 350, the fuel blocks 82 may respectively pass through the slots 352. Moreover, a width W1 of each of the slots 352 may be designed to be substantially equal to a width W2 of the corresponding fuel block 82, so as to effectively wipe the liquid water 50 on each of the fuel blocks 82.

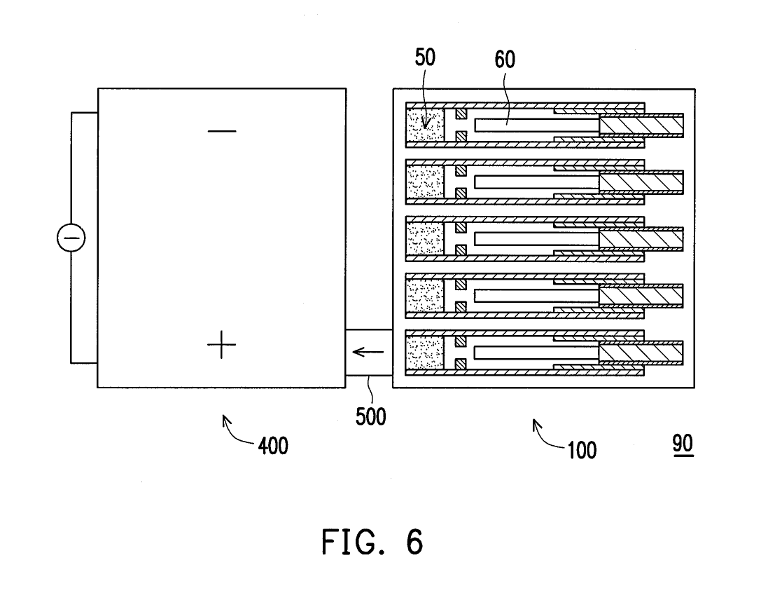

All of the aforementioned hydrogen generating apparatus may be applied to the fuel cell to provide the hydrogen required by the anode reaction of the fuel cell. The hydrogen generating apparatus 100 of FIG. 1 is taken as an example for description. FIG. 6 is a schematic diagram illustrating a fuel cell with the hydrogen generating apparatus of FIG. 1. Referring to FIG. 6, the fuel cell 90 of the embodiment includes the hydrogen generating apparatus 100 of FIG. 1 (multiple of the hydrogen generating apparatuses 100 are illustrated), a cell stack 400 and a guiding structure 500. The guiding structure 500 is connected between the hydrogen generating apparatus 100 and the cell stack 400, and is used for guiding the hydrogen generated through the reaction between the solid fuel 60 and the liquid water 50 to the cell stack 400, so as to provide the hydrogen required by the anode reaction of the cell stack 400. It should be noticed that the oxygen required by cathode reaction of the cell stack 400 is, for example, provided by another supply source, which is not illustrated and described in the embodiment. The fuel cell 90 of the embodiment may be used in electronic devices such as notebook computers or mobile phones, etc. or may be used in transport such as vehicles or ships, etc.

In summary, according to the above descriptions, the embodiments of the invention have at least one of the following advantages. The sliding element slidably disposed on the sleeve may be positioned to the first position and the second position by the withdrawing mechanism, so that the solid fuel connected to the sliding element may be close to or apart from the liquid water contained in one end of the sleeve. In this way, the solid fuel may react with the liquid water to generate the hydrogen or the reaction between the solid fuel and the liquid water may be stopped to achieve an effect of stepwise reaction. Moreover, the water wiper is configured in the sleeve to wipe the liquid water attached to the solid fuel. In this way, the liquid water is avoided to be taken to the other regions in the sleeve, so as to ensure that the reaction between the liquid water and the solid fuel is carried on at the end of the sleeve, so that the generated hydrogen is easy to be collected for utilization.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A hydrogen generating apparatus, adapted to a fuel cell, the hydrogen generating apparatus comprising:
a sleeve, having a first end containing liquid water;
a sliding element, slidably disposed at a second end of the sleeve, wherein a solid fuel is connected to the sliding element; and
a withdrawing mechanism, disposed in the sleeve, wherein the solid fuel is apart from the liquid water when the sliding element is fixed to a first position by the withdrawing mechanism, and the solid fuel reacts with the liquid water to generate hydrogen when the sliding element is fixed to a second position by the withdrawing mechanism.

2. The hydrogen generating apparatus as claimed in claim 1, wherein the solid fuel is fixed on the sliding element, and the withdrawing mechanism comprises:
an external thread, disposed on an outer surface of the sliding element; and
an internal thread, disposed on an inner wall of the sleeve, wherein the external thread is engaged to the internal thread.

3. The hydrogen generating apparatus as claimed in claim 1, wherein the withdrawing mechanism comprises:
a first buckle element, disposed on an outer surface of the sliding element;
a second buckle element, disposed on an inner surface of the sleeve, wherein when the sliding element is located at the second position, the first buckle element and the second buckle element form a structural interference, so as to fix the sliding element to the second position; and
an elastic element, connected between the sleeve and the sliding element, wherein the sliding element is restored to the first position due to an elastic force of the elastic element when the structural interference is released.

4. The hydrogen generating apparatus as claimed in claim 1, further comprising:
a water wiper, disposed in the sleeve and located between the sliding element and the liquid water, wherein the water wiper wipes the liquid water attached on the solid fuel during a process that the sliding element moves from the second position to the first position.

5. The hydrogen generating apparatus as claimed in claim 4, wherein the solid fuel comprises a plurality of fuel blocks, the fuel blocks are separately arranged, and the water wiper has a plurality of slots respectively aligning to the fuel blocks.

6. The hydrogen generating apparatus as claimed in claim 5, wherein a width of each of the slots is substantially equal to a width of the corresponding fuel block.

7. The hydrogen generating apparatus as claimed in claim 1, further comprising a water absorbing structure disposed at the first end for absorbing the liquid water.

8. A fuel cell, comprising:
a hydrogen generating apparatus, comprising:
a sleeve, having a first end containing liquid water;
a sliding element, slidably disposed at a second end of the sleeve, wherein a solid fuel is connected to the sliding element;
a withdrawing mechanism, disposed in the sleeve, wherein the solid fuel is apart from the liquid water when the sliding element is fixed to a first position by the withdrawing mechanism, and the solid fuel reacts with the liquid water to generate hydrogen when the sliding element is fixed to a second position by the withdrawing mechanism;
a cell stack; and
a guiding structure, connected between the hydrogen generating apparatus and the cell stack, for guiding the hydrogen generated through reaction between the solid fuel and the liquid water to the cell stack.

9. The fuel cell as claimed in claim 8, wherein the solid fuel is fixed on the sliding element, and the withdrawing mechanism comprises:
an external thread, disposed on an outer surface of the sliding element; and
an internal thread, disposed on an inner wall of the sleeve, wherein the external thread is engaged to the internal thread.

10. The fuel cell as claimed in claim 8, wherein the withdrawing mechanism comprises:
a first buckle element, disposed on an outer surface of the sliding element;
a second buckle element, disposed on an inner surface of the sleeve, wherein when the sliding element is located at the second position, the first buckle element and the second buckle element form a structural interference, so as to fix the sliding element to the second position; and
an elastic element, connected between the sleeve and the sliding element, wherein the sliding element is restored to the first position due to an elastic force of the elastic element when the structural interference is released.

11. The fuel cell as claimed in claim 8, further comprising:
a water wiper, disposed in the sleeve and located between the sliding element and the liquid water, wherein the water wiper wipes the liquid water attached on the solid fuel during a process that the sliding element moves from the second position to the first position.

12. The fuel cell as claimed in claim 11, wherein the solid fuel comprises a plurality of fuel blocks, the fuel blocks are separately arranged, and the water wiper has a plurality of slots respectively aligning to the fuel blocks.

13. The fuel cell as claimed in claim 12, wherein a width of each of the slots is substantially equal to a width of the corresponding fuel block.

14. The fuel cell as claimed in claim 8, further comprising a water absorbing structure disposed at the first end for absorbing the liquid water.
